(19) United States
(12) Patent Application Publication
(10) Pub. No.: US 2024/0119156 A1
(43) Pub. Date: Apr. 11, 2024

(54) SYSTEM AND METHOD FOR AUTOMATED SOFTWARE DEVELOPMENT COMPLIANCE VERIFICATION AND AUDITING

(71) Applicant: Change Healthcare Holdings, LLC, Nashville, TN (US)

(72) Inventors: Gary Allan Stewart, Trabuco Canyon, CA (US); Sang Ngoc Huynh, Auburn, WA (US); Michael Hoak, Seattle, WA (US); Dennis Day, Dubuque, IA (US); Chris Compton, Fort Worth, TX (US)

(21) Appl. No.: 18/045,488

(22) Filed: Oct. 11, 2022

(51) Int. Cl. G06F 21/57; G06F 8/77

(52) U.S. Cl. CPC G06F 21/572; G06F 8/77; G06F 2221/033

(57) ABSTRACT

A system for verifying software development compliance includes a processor and memory having instructions stored thereon that, when executed by the processor, cause the system to determine that a user has submitted a change to source code stored in a source code repository and, before merging the change with the source code, to perform a compliance analysis of the source code repository by comparing parameters of the source code repository against a set of compliance rules and block the change from being merged with the source code if it is determined that the source code repository is non-compliant. A report is then generated that includes details of the compliance analysis, wherein the report indicates at least whether the source code repository passed or failed for each rule of the set of compliance rules.

### BACKGROUND

Information security (InfoSec) is an increasingly important aspect of software development. For example, it is important to protect sensitive information by validating the integrity of software applications and systems before it is distributed to end users to protect both the software developer and the end users. Software development security encompasses various processes and practices that help to ensure software is secure. In some cases, software developers are subject to compliance rules and regulations when creating, managing, and releasing source code and/or software application changes to maintain security and ensure best practices.

### SUMMARY

One implementation of the present disclosure is a system for verifying software development compliance. The system includes a processor and memory having instructions stored thereon that, when executed by the processor, cause the system to determine that a user has submitted a change to source code stored in a source code repository and, before merging the change with the source code, to perform a compliance analysis of the source code repository by comparing parameters of the source code repository against a set of compliance rules, and block the change from being merged with the source code if it is determined that the source code repository is non-compliant. A report is then generated that includes details of the compliance analysis that indicates at least whether the source code repository passed or failed for each rule of the set of compliance rules.

In some implementations, the instructions further cause the system to automatically approve merging of the change with the source code if it is determined that the source code repository is compliant.

In some implementations, the instructions further cause the system to present, to a user of a user device, a graphical user interface (GUI) that includes the report.

In some implementations, the instructions further cause the system to generate an alert responsive to a determining that the source code repository is non-compliant and transmit the alert to a remote user device.

In some implementations, the system is communicably coupled to the source code repository by an application programming interface (API) and the parameters of the source code repository are retrieved via an API call to the source code repository.

In some implementations, the system wrapped around an application programming interface (API) for a source code management system that includes the source code repository.

In some implementations, the report is displayed to a user of the system via a console output and/or is transmitted to a remote device in one or more of a Junit, HyperText Markup Language (HTML), delimited file, or text-based format.

In some implementations, the instructions further cause the system to receive the set of compliance rules via a user input.

In some implementations, the set of compliance rules include at least one rule where a number of approvals for merging the modification with the source code must be greater than one, an author of the modification to the source code cannot approve merging of the modification with the source code, the modification to the source code can only be merged with the source code if each step of a software development pipeline is passed, all discussions relating to the source code repository are completed or closed, or a visibility of the source code repository is set to private or internal.

Another implementation of the present disclosure is a method for verifying software development compliance. The method includes determining that a user has submitted a change to source code stored in a source code repository and, before merging the change with the source code, performing a compliance analysis of the source code repository by comparing parameters of the source code repository against a set of compliance rules and blocking the change from being merged with the source code if it is determined that the source code repository is non-compliant. The method also includes generating a report that includes details of the compliance analysis that indicates at least whether the source code repository passed or failed for each rule of the set of compliance rules.

In some implementations, the method further includes automatically approving merging of the change with the source code if it is determined that the source code repository is compliant.

In some implementations, the method further includes presenting, to a user of a user device, a graphical user interface (GUI) that includes the report.

In some implementations, the method further includes generating an alert responsive to a determining that the source code repository is non-compliant and transmitting the alert to a remote user device.

In some implementations, the parameters of the source code repository are retrieved via an application programming interface (API) call to the source code repository.

In some implementations, the report is displayed to a user of the system via a console output and/or is transmitted to a remote device in one or more of a Junit, HyperText Markup Language (HTML), delimited file, or text-based format.

In some implementations, the method further includes receiving the set of compliance rules via a user input.

In some implementations, the set of compliance rules include at least one rule where a number of approvals for merging the modification with the source code must be greater than one, an author of the modification to the source code cannot approve merging of the modification with the source code, the modification to the source code can only be merged with the source code if each step of a software development pipeline is passed, all discussions relating to the source code repository are completed or closed, or a visibility of the source code repository is set to private or internal.

Yet another implementation of the present disclosure is a method for verifying software development compliance. The method includes scanning a source code repository at a regular interval to determine a most recent set of parameters for the source code repository, performing a compliance analysis of the source code repository by comparing the most recent set of parameters for the source code repository against a set of compliance rules, blocking any submitted code changes within the source code repository from being merged with corresponding source code if it is determined that the source code repository is non-compliant, and generating a report that includes details of the compliance analysis that indicates at least whether the source code repository passed or failed for each rule of the set of compliance rules.

In some implementations, the method further includes detecting whether a change to code stored in the source code repository has been submitted since a previous scan, such that the compliance analysis of the source code repository is performed only if a change is detected.

In some implementations, the method further includes automatically approving the merging of any changes with the corresponding source code if it is determined that the source code repository is compliant.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Various objects, aspects, and features of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a software development compliance verification architecture, according to some implementations.

FIG. 2 is a detailed block diagram of the compliance evaluation system of FIG. 1, according to some implementations.

FIGS. 3 and 4 are flow charts of different processes for verifying software development compliance, according to some implementations.

FIG. 5 is an example user interface for establishing or modifying report schedules, according to some implementations.

FIG. 6 is an example user interface of a color-coded console output from the compliance evaluation system of FIG. 1, according to some implementations.

FIG. 7 is an example user interface of a summary report generated by the compliance system of FIG. 1, according to some implementations.

FIG. 8 is an example user interface for viewing details of various compliance rules, according to some implementations.

FIG. 9 is an example user interface for detailed reporting of the results of a compliance analysis, according to some implementations.

FIG. 10 is an example user interface of summary view for active and completed compliance checks, according to some implementations.

FIG. 11 is an example user interface of a notification of non-compliance presented via a collaborative communication platform, according to some implementations.

### DETAILED DESCRIPTION

Current controls and practices for compliance verification in software development, if implemented at all, are often labor-intensive and time-consuming, requiring multiple stages of human intervention and manual control which delay software updates and releases. One such compliance practice, for example, is the separation of duties (e.g., the developer/engineer writing code does not touch the production environment, the code goes from developer/engineer to quality analyst (QA) to production engineer, etc.), which would require collusion between multiple actors for nefarious code to be pushed to production. However, the practice of separation of duties is not conducive to a DevOps model, which generally includes the merging of roles and operating in a continuous integration and continuous delivery (Cl/CD) pipeline. Manual compliance verification is also prone to inaccuracy or incompleteness and does not create a record for compliance auditing. Additionally, reliance on manual compliance checks does not provide a mechanism to prevent nefarious code from being released.

Referring generally to the figures, a system and methods for verifying and auditing software development compliance are shown that address these and other shortcomings, according to various implementations. At a high level, a compliance evaluation system or “tool” is configured to interface with one or more source code repositories or source code management (SCM) systems in order to verify that various settings and parameters are in place and enforced when source code is written, edited, or otherwise manipulated. In this manner, the compliance evaluation system and methods described herein can ensure that the source code repositories or SCM systems are compliant with various compliance rules or regulations before submitted code changes are merged with corresponding source code and/or before any source code is released to production. In some implementations, the system and methods described herein act as a “gateway” in a pipeline to ensure that no source code can be released where the corresponding project has not passed compliance verification. Additionally, or alternatively, in some implementations, the system and methods described herein can continuously scan source code repositories and/or SCM systems for compliance.

In some implementations, the compliance evaluation system compares parameters (e.g., settings) of a source code repository or SCM system to a set of compliance rules, which may be defined by a user of the compliance evaluation system or a third-party. The source code repository or SCM system may be deemed “compliant” if each of the set of compliance rules is passed or “non-compliant” if one or more rules are failed. If the source code repository or SCM system is determined to be compliant, the compliance evaluation system may automatically approve the merging of code changes submitted by various users with the source code. If, however, the source code repository or SCM system is determined to be non-compliant, the compliance evaluation system may automatically block the merging of code changes and may notify a user of the compliance evaluation system. In either case, the compliance evaluation system may generate a record of each compliance analysis, thereby creating a log for compliance auditing.

### Overview

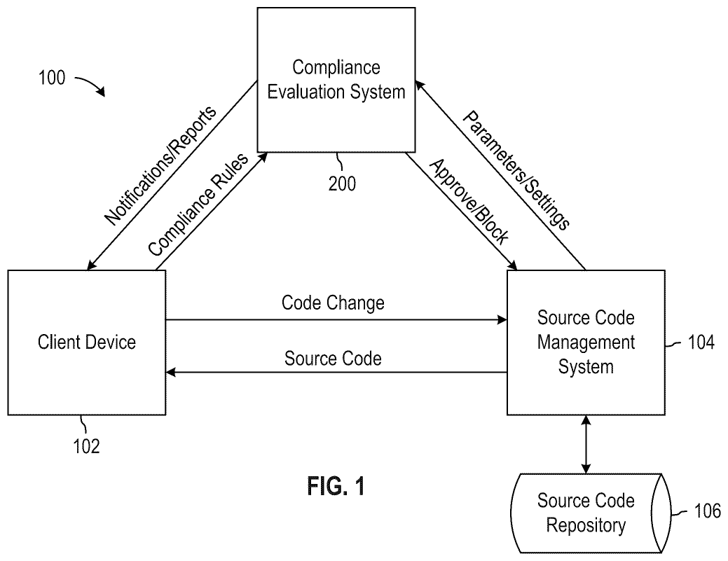

To better understand how the system and methods described herein fit into a software development pipeline, reference is first made to FIG. 1 which shows a block diagram of an example software development compliance verification architecture 100, according to some implementations. As described herein, a development “pipeline” is a set of scripts that run to implement a code change or, more specifically, to merge a code change (e.g., a “branch”) with its corresponding source code (e.g., a “trunk”). As shown, architecture 100 includes a client device 102, a source code management (SCM) system 104, and a compliance evaluation system 200, which may be in electronic communication. In some implementations, client device 102, SCM system 104, and compliance evaluation system 200 are communicably coupled via a network, such as a local area network (LAN), a wide area network (WAN) (e.g., the Internet), an enterprise private network (EPN), a virtual private network (VPN), or the like. In other implementations, one or more of client device 102, SCM system 104, and compliance evaluation system 200 are directly connected (e.g., via a wire or cable). In any case, each of client device 102, SCM system 104, and compliance evaluation system 200 may be configured to send and receive digital data from the other components of architecture 100.

Client device 102 is generally any computing device that can be operated by a user to create, edit, and/or view source code. For example, client device 102 may be a desktop or laptop computer, a workstation, a server, a smartphone, etc. In general, client device 102 includes at least one processor and memory which stores instructions that are executable by the at least one processor to cause client device 102 to perform various operations described herein. In some implementations, client device 102 includes a user interface for displaying text, images, and other data to a user and/or for receiving user inputs. For example, client device 102 may include a display screen (e.g., LED, LCD, etc.) and/or one or more user input devices, such as a keyboard, a keypad, a mouse, a touchscreen, etc. While shown as only a single device, it should be appreciated that client device 102 may represent any number of different or similar computing devices.

As described herein, SCM system 104 and any other source code management systems or tools are configured to track modifications and/or management changes to a source code repository 106, herein referred to as “repository 106”. Source code management ensures that developers/engineers are working on up-to-date code and helps to prevent conflicts when code is edited. SCM system 104 is generally any known source code management system or tool, such as GitHub, Git, GitLab, Concurrent Versions System (CVS), Vesta, or the like. In some implementations, SCM system 104 is hosted on an independent computing device that has at least one processor and memory, such as a desktop or laptop computer, a workstation, a server, a smartphone, etc. In some implementations, SCM system 104 is cloud-based or otherwise remotely accessible by client device 102. For example, client device 102 may run a local program or may use a web browser to access and interact with SCM system 104. In some such implementations, SCM system 104 may include a corresponding application programing interface (API) that client device 102 can call to communicate data with SCM system 104.

Repository 106 is a file archive or database that stores and maintains source code. In some implementations, repository 106 is remote from SCM system 104 and is therefore remotely accessed by SCM system 104. For example, repository 106 may be stored on a separate computing device (e.g., a server) from SCM system 104. In some implementations, repository 106 is maintained in the cloud (e.g., on a cloud-based server). In other implementations, repository 106 is a component of SCM system 104. For example, repository 106 may be a database maintained by SCM system 104 and is therefore located on the same computing device as SCM system 104. It should be appreciated that, while only one of SCM system 104 and repository 106 are shown in FIG. 1, architecture 100 may include any number of SCM systems/tools and source code repositories. For example, multiple different client devices can interact with multiple different SCMs and/or multiple different source code repositories.

As shown, in some implementations, a user of client device 102 may access source code maintained by SCM system 104 and/or stored in repository 106 for viewing and/or editing (e.g., modification). It should be noted that source code is not necessarily downloaded or received by client device 102 directly (although it may be, in some cases). Rather, in some implementations, a copy of the source code is received by client device 102. In some implementations, source code is maintained by SCM system 104/repository 106, and users submit changes which are only merged with the source code once approved. More commonly, in some implementations, client device 102 accesses the source code remotely through an SCM API associated with SCM system 104. For example, client device 102 may execute a local software application (e.g., a software development environment) that transmits API calls to SCM system 104 or an SCM API in order to send/receive data. Thus, the source code may be maintained in the secure environment of SCM system 104 and/or repository 106, and the SCM system 104 and/or repository 106 manage the merging of code changes to coordinate for multiple users. Thus, through client device 102, users may submit code changes that are transmitted to SCM system 104 and/or repository 106.

Compliance evaluation system 200, which is described below in greater detail, is shown to be in communication with one or both of client device 102 and SCM system 104. Compliance evaluation system 200, alternatively referred to as a “compliance tool,” may be a stand-alone computing device (e.g., a server or workstation) or may be hosted on a computing device that performs other operations. For example, in some implementations, compliance evaluation system 200 may be implemented via software on any suitable computing device. In some implementations, compliance evaluation system 200 is hosted on a cloud server and is therefore cloud-based. In some implementations, compliance evaluation system 200 includes a corresponding API through which client device 102 and/or SCM system 104 send and receive data. In some implementations, compliance evaluation system 200 “wraps around” SCM system 104 and/or an API for SCM system 104, as described in greater detail below.

Unlike many other technologies that only verify the integrity of source code itself, compliance evaluation system 200 is generally configured to verify the compliance of source code management systems (e.g., SCM system 104) and/or source code repositories (e.g., repository 106) in which code is stored, edited, and/or published. In particular, compliance evaluation system 200 may determine whether SCM system 104 and/or repository 106 are compliant with various compliance rules and/or regulations. In some implementations, these compliance rules and/or regulations are user-defined, such as by a user of client device 102. As shown in FIG. 1, for example, compliance evaluation system 200 may receive compliance rules from client device 102. In some such implementations, a user of client device 102 may define the compliance rules (e.g., using a configuration tool or program). In some implementations, compliance rules and/or regulations are defined by a third party, such as a regulatory body. For example, compliance evaluation system 200 may receive compliance rules from another remote computing device (e.g., via the Internet), such as a server operated by a compliance entity, and/or from a database of compliance rules.

As described herein, each compliance rule may relate to a parameter of SCM system 104 and/or repository 106. Parameters, as defined herein, are various settings, controls, and/or guidelines that are implemented by SCM system 104 and/or repository 106 with regards to the creation, management, and release of source code. In some implementations, parameters are project and/or repository specific. For example, separate parameters can be defined for each project in repository 106 and/or for repository 106 itself. As another example, SCM system 104 may manage multiple source code repositories, each with a unique set of parameters. In some implementations, parameters are specific to SCM system 104. For example, different SCM systems may apply unique settings to managed projects.

A rule that is “passed” indicates that the corresponding parameter of SCM system 104 and/or repository 106 is “compliant” with the particular rule. Likewise, a rule that is “failed” indicates that the corresponding parameter of SCM system 104 and/or repository 106 is “non-compliant” with the particular rule. In some implementations, SCM system 104 and/or repository 106 is only deemed to be compliant if each and every rule in a compliance rule set are passed. Accordingly, in some such implementations, if one or more rules are failed, SCM system 104 and/or repository 106 may be deemed non-compliant. In other implementations, a threshold may be set such that, if more than a threshold number of rules pass, SCM system 104 and/or repository 106 is deemed compliant. In some implementations, rules may be tiered based on importance and/or certain rules may be indicated as “must pass,” such that only the most important (e.g., above a threshold level) or “must pass” rules are required to be passed in order for SCM system 104 and/or repository 106 to be deemed compliant.

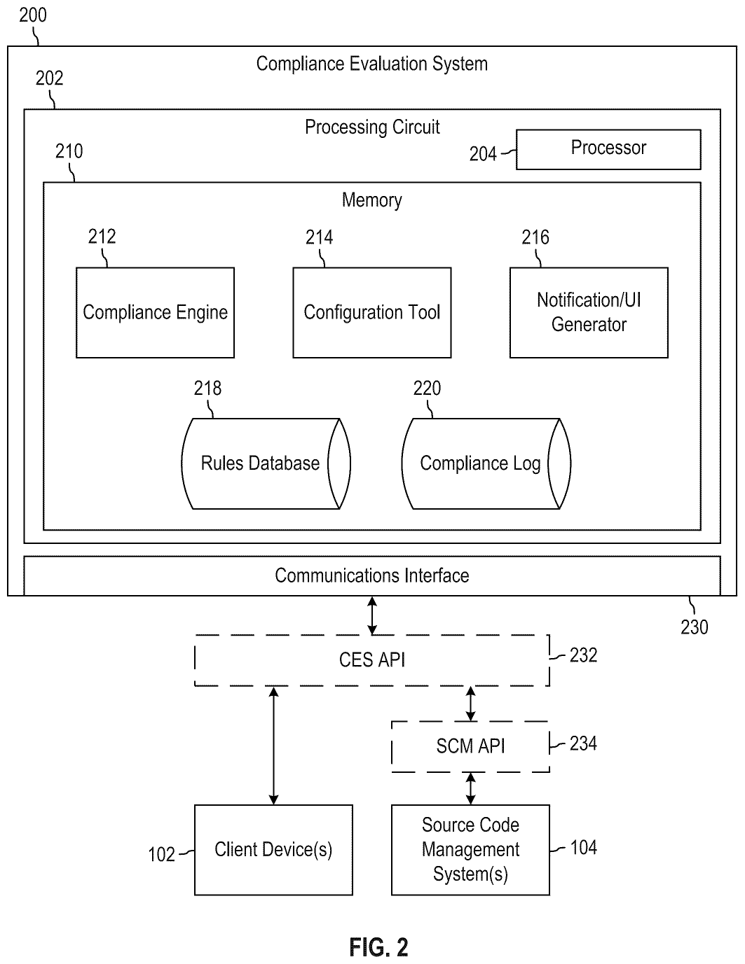

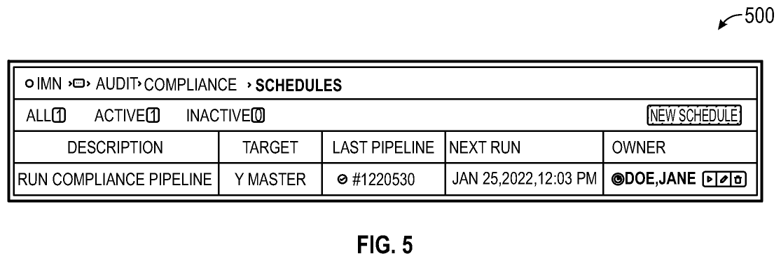

A wide range of compliance rules can be defined by a user or third party. For example, various compliance rules can include: a number of approvals for merging the modification with the source code must be greater than one; an author of the modification to the source code cannot approve merging of the modification with the source code; only code owners (e.g., a predefined set of users) can approve of code changes; a modification to source code can only be merged with the source code if each step of a software development pipeline is passed; all discussions relating to the source code repository are completed or closed; and/or a visibility of the source code repository is set to private or internal. It should be appreciated, however, that these compliance rules are provided only as an example and the compliance rules considered by compliance evaluation system 200 are not limited to those listed herein. The configuration of compliance rules is described below in greater detail with respect to FIGS. 2 and 5.

Still referring to FIG. 1, compliance evaluation system 200 is shown to obtain parameters from SCM system 104 and/or repository 106. In some implementations, such as where compliance evaluation system 200 is wrapped around SCM system 104, repository 106, and/or an API for SCM system 104, compliance evaluation system 200 may access parameters on demand. For example, in some implementations, compliance evaluation system 200 may call the API for SCM system 104 to obtain various parameters for SCM system 104 and/or repository 106. In some implementations, compliance evaluation system 200 retrieves said parameters from SCM system 104 and/or repository 106. For example, compliance evaluation system 200 may transmit a command or request to SCM system 104 and/or repository 106 which causes SCM system 104 and/or repository 106 to respond with the requested parameters. In some implementations, SCM system 104 and/or repository 106 transmit their corresponding parameters to compliance evaluation system 200 continuously or at regular intervals.

Once the parameters for SCM system 104 and/or repository 106 are obtained, compliance evaluation system 200 may perform a compliance check by comparing each parameter to a set of compliance rules to determine compliance. In some implementations, compliance evaluation system 200 performs compliance checks on a regular basis. For example, compliance evaluation system 200 may scan one or more repositories (e.g., repository 106) at a regular interval to check for compliance. In some implementations, compliance evaluation system 200 continuously checks compliance. For example, compliance evaluation system 200 may detect changes to parameters in SCM system 104 and/or repository 106. In some implementations, compliance evaluation system 200 performs a compliance check if a modification to source code is detected.

As described herein, SCM system 104/repository 106 are generally configured for trunk-based development, where users create “branches” by submitting code changes or updates. These “branches” are then merged by SCM system 104 with a “trunk,” which refers to the source code itself (e.g., the original code). Accordingly, if SCM system 104 and/or repository 106 are deemed compliant, compliance evaluation system 200 may automatically approve the merging of a code change (e.g., a branch) with the source code (e.g., the trunk). Compliance evaluation system 200 may also be configured to block the merging of code changes (e.g., branches) with the source code (e.g., trunk) if the SCM system 104 and/or repository 106 is deemed non-compliant. In some implementations, compliance evaluation system 200 may transmit, to SCM system 104 and/or repository 106, a command that approves or blocks the merging of code changes based on the compliance analysis. In other implementations, compliance evaluation system 200 may act as an intermediary and may directly prevent code changes from being merged and/or may prevent the code itself from being released (e.g., by preventing SCM system 104 from transmitting data associated with the non-compliant repository or project). In some implementations, for example, compliance evaluation system 200 may cause the development pipeline to fail, preventing a code change from being merged with a trunk.

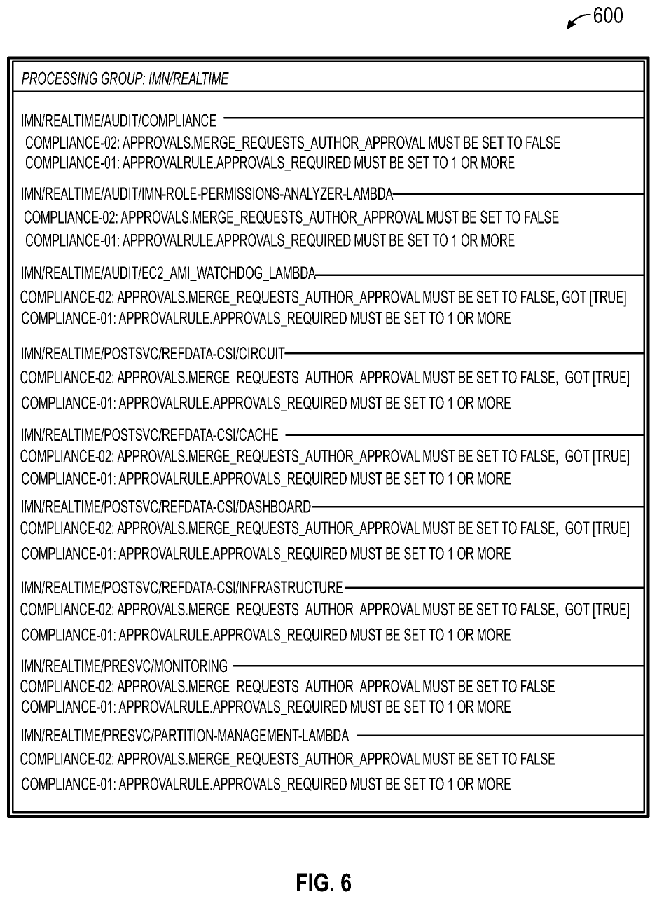

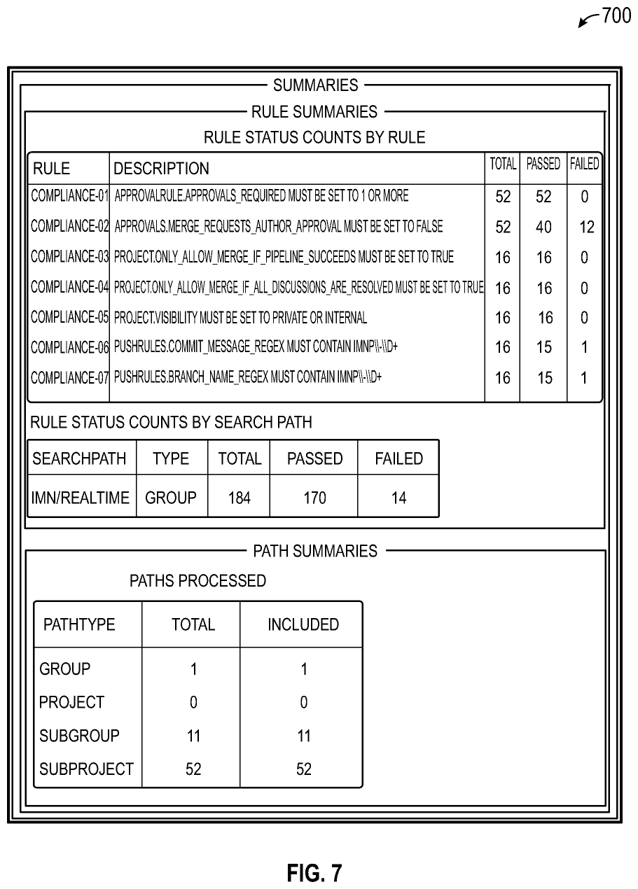

In some implementations, compliance evaluation system 200 may generate a report or log for each completed compliance check. The report or log may indicate, for example, general information about the compliance check (e.g., time of the compliance check, reason for the compliance check, repository analyzed, etc.) as well as detailed results of the compliance check (e.g., a pass/fail indication for each compliance rule). The report may also indicate whether code modifications are automatically approved or blocked. In some implementations, compliance evaluation system 200 generates and transmits (e.g., to client device 102) a notification based on a compliance check. For example, the notification may alert the user that one of SCM system 104 and/or repository 106 are non-compliant, and/or that code changes have been blocked from merging. Additionally, in some implementations, a log is generated for auditing purposes. Example reports/logs are shown in FIGS. 6 and 7, discussed in detail below.

### Compliance Evaluation System

Referring now to FIG. 2, a detailed block diagram of compliance evaluation system 200 is shown, according to some implementations. As described above, compliance evaluation system 200 is generally configured to determined whether source code management systems (e.g., SCM system 104) and/or source code repositories (e.g., repository 106) are compliant with a predefined set of compliance rules. Based on the determination of compliance, compliance evaluation system 200 may initiate various response actions, such as generating a report, generating and/or presenting a graphical user interface (GUI), transmitting notifications, etc. Perhaps most notably, however, compliance evaluation system 200 may automatically approve or block the merging of code changes (e.g., branches) with the source code itself (e.g., trunk). In this manner, compliance evaluation system 200 actively prevents non-compliant, and therefore possibly nefarious, code from being released. Further, those of skill in the art will appreciate that compliance evaluation system 200 helps to ensure the integrity of the software development process/pipeline itself, rather than simply checking for errors in source code.

Compliance evaluation system 200, hereinafter referred to as “system 200,” is shown to include a processing circuit 202 that includes a processor 204 and a memory 210. Processor 204 can be a general-purpose processor, an application specific integrated circuit (ASIC), one or more field programmable gate arrays (FPGAs), a group of processing components, or other suitable electronic processing components. In some implementations, processor 204 is configured to execute program code stored on memory 210 to cause system 200 to perform one or more operations. Memory 210 can include one or more devices (e.g., memory units, memory devices, storage devices, etc.) for storing data and/or computer code for completing and/or facilitating the various processes described in the present disclosure.

In some implementations, memory 210 includes tangible, computer-readable media that stores code or instructions executable by processor 204. Tangible, computer-readable media refers to any media that is capable of providing data that causes system 200 to operate in a particular fashion. Example tangible, computer-readable media may include, but is not limited to, volatile media, non-volatile media, removable media and non-removable media implemented in any method or technology for storage of information such as computer readable instructions, data structures, program modules or other data. Accordingly, memory 210 can include random access memory (RAM), read-only memory (ROM), hard drive storage, temporary storage, non-volatile memory, flash memory, optical memory, or any other suitable memory for storing software objects and/or computer instructions. Memory 210 can include database components, object code components, script components, or any other type of information structure for supporting the various activities and information structures described in the present disclosure. Memory 210 can be communicably connected to processor 204, such as via processing circuit 202, and can include computer code for executing (e.g., by processor 204) one or more processes described herein. While shown as individual components, it will be appreciated that processor 204 and/or memory 210 can be implemented using a variety of different types and quantities of processors and memory. For example, processor 204 may represent a single processing device or multiple processing devices.

Similarly, memory 210 may represent a single memory device or multiple memory devices. Additionally, in some implementations, system 200 may be implemented within a single computing device (e.g., one server, one housing, etc.). In other implementations, system 200 may be distributed across multiple servers or computers (e.g., that can exist in distributed locations). For example, system 200 may include multiple distributed computing devices (e.g., multiple processors and/or memory devices) in communication with each other that collaborate to perform operations. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. For example, virtualization software may be employed by system 200 to provide the functionality of a number of servers that is not directly bound to the number of computers in system 200.

While shown in FIG. 2 as components of system 200, in some implementations, processing circuit 202, processor 204, and/or memory 210 may be components of another computing device. For example, processing circuit 202, processor 204, and/or memory 210 may be shared between system 200 and another system or device. In some such implementations, the functionality of memory 210 and the components thereof may be implemented by the computing device on which system 200 is hosted. In some implementations, for example, system 200 is hosted on a cloud server (e.g., is cloud-based). For example, system 200 may be implemented as a software application on the cloud server or another computing device. In this manner, the computational load of performing compliance analysis is handled by a suitable computing device and is not off-loaded onto client device 102 or SCM system 104, for example.

Memory 210 is shown to include a compliance engine 212 which obtains SCM system and/or repository parameters for compliance analysis, and which performs the compliance analysis processes described herein. As described above, in some implementations, compliance engine 212 may request parameters from an SCM system or repository, such as via an API call or by sending a command/prompt. In some implementations, compliance engine 212 is configured to retrieve the parameters itself. For example, system 200 may have permission to access the settings of an SCM system or repository to identify the various parameters. In some implementations, compliance engine 212 receives parameters automatically (e.g., without transmitting a request). In any case, compliance engine 212 may perform a compliance analysis by comparing each parameter for an SCM system or repository with a set of compliance rules, which may be maintained in a rules database 218. For each rule, compliance engine 212 may assign a value of “pass” or “fail” based on the comparison with a corresponding parameter. Alternatively, compliance engine 212 may assign a numerical value (e.g., ‘0’ or ‘1’) indicating whether each rule is passed or failed.

In some implementations, rules database 218 may maintain multiple sets of compliance rules. For example, system 200 may interface (e.g., via a compliance evaluation system (CES) API 232, described below) with multiple different client devices 102 that each define a unique set of compliance rules. Similarly, different compliance rules may apply to each SCM system or repository that is monitored by system 200. In some implementations, compliance engine 212 may use an identifier associated with an SCM system or repository that is being evaluated for compliance to identify a corresponding set of compliance rules to retrieve or access from rules database 218.

Once each rule of a set of compliance rules has been evaluated against the corresponding parameters from the SCM system or repository being evaluated, compliance engine 212 may make a determination as to whether the SCM system or repository is complaint. As mentioned above, in some implementations, the SCM system/repository is only complaint if every rule is passed. In other implementations, only a subset of the compliance rules needs to be passed for the SCM system/repository to be considered compliant. Based on the determination of compliance, compliance engine 212 may automatically initiate various response actions. In some implementations, if the SCM system/repository is deemed compliant, then compliance engine 212 may automatically approve the merging (e.g., with source code) or release any code changes associated with the compliant SCM system/repository. If, however, the SCM system/repository is deemed non-compliant, then compliance engine 212 may automatically block any code changes from being released or merged with the associated source code. For example, compliance engine 212 may transmit a command to the SCM system/repository to prevent the SCM system/repository from merging code. As another example, compliance engine 212 may prevent the code from being released to external devices. In this manner, compliance engine 212 actively prevents nefarious code from being released.

In either situation, compliance engine 212 also generates a report of the compliance analysis. The report may indicate, for example, whether the SCM system/repository being evaluated is compliant or non-compliant with the associated compliance rules. The report may also indicate the specific compliance rules being used for evaluation. In some implementations, the report indicates each rule that the SCM system/repository passed or failed. In some implementations, the report indicates additional information such as the time of the compliance check, a reason for performing the compliance check, etc. In some implementations, reports are stored in a compliance log 220 to create an audit trail. To this point, users (e.g., auditors) may access historic compliance analysis records from compliance log 220 to ensure that a software developer or business is following compliance standards.

Memory is further shown to include a configuration tool 214 that allows a user to edit compliance rules and compliance check schedules, as well as to make other changes to system 200. In some implementations, users interact with system 200 remotely (e.g., from client devices 102) via CES API 232. Thus, configuration tool 214 may make changes to various settings, compliance rules, etc., based on user inputs. In some implementations, users may define or modify compliance rules, as described above. Accordingly, configuration tool 214 may modify (e.g., add, delete, edit) the sets of compliance rules stored in rules database 218 based on user inputs. An example of user-defined compliance rules is shown below:

```
″rule_definitions″: {
  ″COMPLIANCE-01″: {
    ″model_type″: ″ApprovalRule″,
    ″field_name″: ″approval_required″,
    ″validation″: ″v is not None and v >= 1″,
    ″message″: ″{model_type}.{field_name} must be set to 1
or more″
  },
  ″COMPLIANCE-02″: {
    ″model_type″: ″Approvals″,
    ″field_name″: ″merge_requests_author_approval″,
    ″validation″: ″v is False″,
    ″message″: ″{model_type}.{field_name} must be set to
False″
  },
  ″COMPLIANCE-03″: {
    ″model_type″: ″Project″,
    ″field_name″: ″only_allow_merge_if_pipeline_succeeds″,
    ″validation″: ″v is True″,
    ″message″: ″{model_type}.{field_name} must be set to
True″
  },
  ″COMPLIANCE-04″: {
    ″model_type″: ″Project″,
    ″field_name″:
″only_allow_merge_if_all_discussions_are_resolved″,
    ″validation″: ″v is True″,
    ″message″: ″{model_type}.{field_name} must be set to
True″
  },
  ″COMPLIANCE-05″: {
    ″model_type″: ″Project″,
    ″field_name″: ″visibility″,
    ″validation″: ″v in [′private′, ′internal′]″,
    ″message″: ″{model_type}.{field_name} must be set to
private or internal″
  },
```

In some implementations, configuration tool 214 allows users to filter and apply compliance rules to different SCM systems/repositories, or groups of repositories, as shown below:

```
″default_rules″: [
  ″COMPLIANCE-01″,
  ″COMPLIANCE-02″
],
″custom_rules″: {
  ″imn/realtime/presvc/core/**″: [
    ″COMPLIANCE-03″,
    ″COMPLIANCE-04″,
    ″COMPLIANCE-05″
    ″COMPLIANCE-06″,
    ″COMPLIANCE-07″
  ]
},
```

In some implementations, configuration tool 214 allows users to establish custom delimited output reports, as shown below:

```
″custom_output″: {
  ″field_names″: [″search_path″, ″path″, ″msg_type″,
″rule_id″, ″msg_body″, ″error_data″],
  ″delimiter″: ″,″
}
```

In some implementations, the color scheme for text and/or HTML reports can be customized. For example:

[styles]
skipped = bright_black
passed = bright_green
failed = bright_red
unknown = bright_white on bright_red
path = bold_yellow
heading = bold italic bright_magenta
error = red
status = bright_cyan
output_path = bright_blue
summary.count.skipped = bright_black
summary.count.passed = bright_green
summary.count.failed = bright_red
summary.count.unknown = bright_white on bright_red
summary.count.included = bright_green
summary.count.total = bright_blue
panel.summaries = none
panel.rules_summary = none
panel.path_summary = none
panel.border.summaries = none
panel.border.rules_summary = sky_blue2
panel.border.path_summary = green
table.rule_summary = none
table.search_path_summary = none
table.paths_processed_summary = none
table.row.odd.rule_summary = none
table.row.odd.search_path_summary = none
table.row.odd.paths_processed_summary = none
table.row.even.rule_summary = none
table.row.even.search_path_summary = none
table.row.even.paths_processed_summary = none
table.header.rule_summary = bold bright_magenta
table.header.search_path_summary = bold bright_magenta
table.header.paths_processed_summary = bold bright_magenta
table.footer.rule_summary = bold
table.footer.search_path_summary = bold
table.footer.paths_processed_summary = bold
table.border.rule_summary = blue
table.border.search_path_summary = yellow
table.border.paths_processed_summary = bold
table.title.rule_summary = italic
table.title.search_path_summary = italic
table.title.paths_processed_summary = italic

Additionally, configuration tool 214 may establish schedules for running compliance checks. For example, users can schedule compliance checks to be performed at regular intervals (e.g., every day, every week, etc.), continuously, based on a status of a project, or any time a change to source code is detected. An example user interface for scheduling compliance checks and/or reporting is shown in FIG. 5, described in detail below.

In some implementations, memory 210 includes a notification/user interface (UI) generator 216 that generates and/or presents notifications and graphical user interfaces (GUIs). As described herein, a GUI is a user interface that includes text, images, and/or other graphics. In some implementations, the notifications and/or GUIs generated by notification/UI generator 216 are interactive, such that a user can select text, icons, etc., to interact with system 200. In some implementations, GUIs are presented via a user interface of system 200 (not shown); however, the GUIs generated by notification/UI generator 216 are more commonly transmitted to client devices 102 for display. GUIs, in particular, can be generated and/or transmitted in any suitable format, such as Junit, HyperText Markup Language (HTML), delimited file, or text-based formats. In some implementations, notification/UI generator 216 generates and presents a color-coded console output. Examples of various GUIs are shown in FIGS. 5-10. In some implementations, notification/UI generator 216 is configured to generate GUIs based on the compliance analysis reports produced by compliance engine 212 and/or stored in compliance log 220. For example, notification/UI generator 216 may generate a GUI that provides a textual and/or graphical representation of a compliance analysis. FIGS. 6 and 7, described in detail below, are example GUIs based on compliance analysis reports.

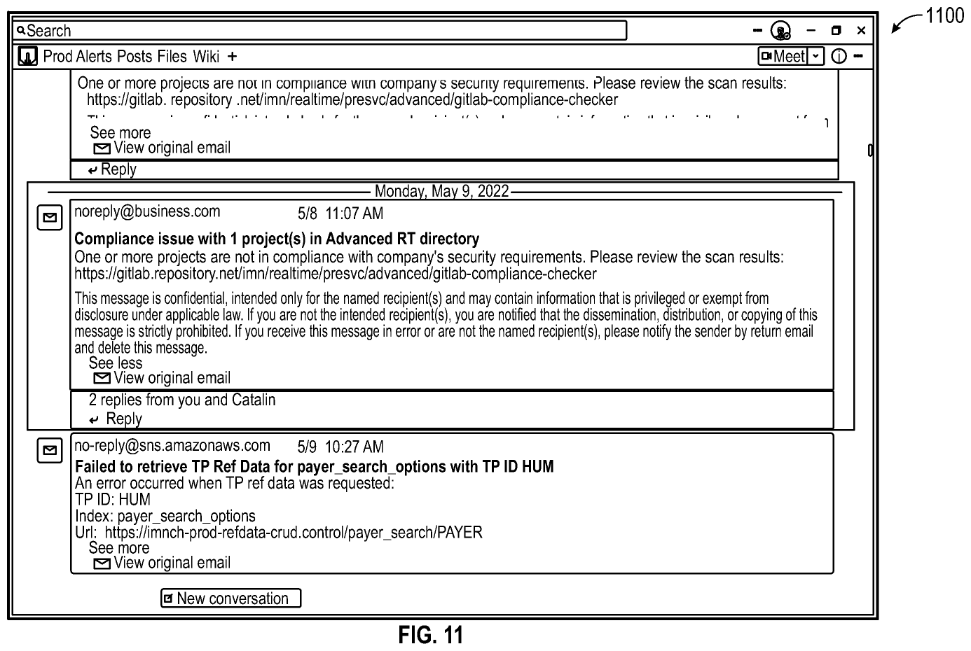

In some implementations, notification/UI generator 216 is configured to generate and transmit, to client devices 102, notifications when an SCM system/repository is evaluated. The notification may indicate, for example, whether the SCM system/repository is compliant or non-compliant. In particular, notification/UI generator 216 may generate a notification to alert a user of client device 102 that an SCM/repository is non-compliant and that code changes are being blocked from release, which allows the user to access system 200 and/or the SCM system/repository to investigate or make changes. In some implementations, the notification may include icons or links that allow the user to initiate further actions, such as overriding a block, scheduling a meeting, etc. In some implementations, notification/UI generator 216 may present notifications to users in a collaborative communications platform or chat, an example of which is shown in FIG. 11. For example, notification/UI generator 216 may generate a post or start a conversation in the collaborative communications platform, which can prompt a development team to address any issues.

Still referring to FIG. 2, system 200 is also shown to include a communications interface 230 that facilitates communications between system 200 and any external components or devices. For example, communications interface 230 can provide means for transmitting data to, or receiving data from, client device(s) 102 and SCM system(s) 104. While not shown, in some implementations, communications interface 230 may also transmit data to/receive data from any number of source code repositories. Accordingly, communications interface 230 can be or can include a wired or wireless communications interface (e.g., jacks, antennas, transmitters, receivers, transceivers, wire terminals, etc.) for conducting data communications. In various implementations, communications via communications interface 230 may be direct (e.g., local wired or wireless communications) or via a network (e.g., a WAN, the Internet, a cellular network, etc.). For example, communications interface 230 can include a WiFi transceiver for communicating via a wireless communications network. In another example, communications interface 230 may include cellular or mobile phone communications transceivers. In yet another example, communications interface 230 is a component of memory 210 that routes data to/from various external sources.

As shown, in some implementations, system 200 may be accessible (e.g., by external devices) via CES API 232. Similarly, in some implementations, one or more SCM systems may be accessible via respective APIs. For simplicity, only a single SCM API 234 is shown which interfaces system 200 with SCM system 104. Thus, in some such implementations, system 200 and any external SCM systems or repositories may be coupled via respective APIs. In some implementations, system 200 is “wrapped around” SCM API 234 or the corresponding SCM system itself. In some implementations, system 200 is a plug-in that can be installed into various SCM systems. Accordingly, system 200 may directly access and/or control SCM system(s) 104 and/or any number of repositories associated with each SCM system.

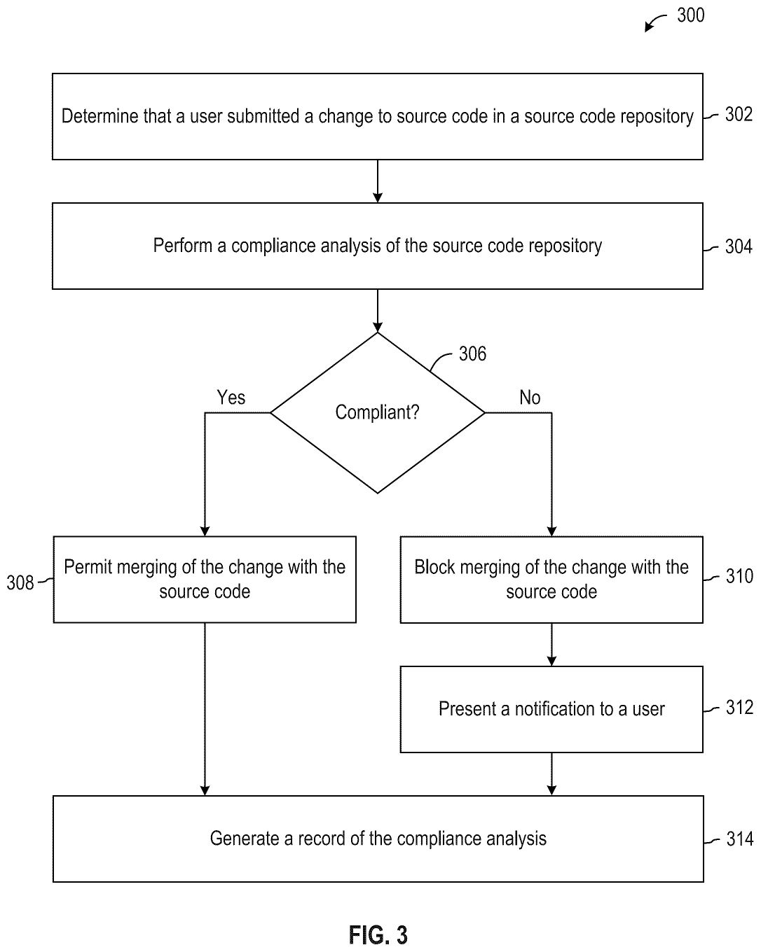

Referring now to FIG. 3, a flow chart of a process 300 for verifying software development compliance is shown, according to some implementations. Specifically, process 300 can be implemented to determine compliance of a source code management system and/or source code repository when a modification to source code is detected (e.g., on-demand). In some implementations, process 300 is implemented by system 200, as described above. It will be appreciated that certain steps of process 300 may be optional and, in some implementations, process 300 may be implemented using less than all of the steps. It will also be appreciated that the order in which the steps of process 300 are shown is not intended to be limiting.

At step 302, a determination is made that a user has submitted a change to source code in a source code repository. As discussed above, for example, a code change submitted by a user can create a “branch” or modified copy of the original (e.g., source) code; thus, system 200 may detect that a branch has been created. In some implementations, system 200 may continuously scan a plurality of source code repositories to detect changes. In some implementations, submitted changes/branches may be reported by the source code repository (e.g., to an associated SCM system), which is then detected by system 200. In some implementations, system 200 determines that a change has been submitted as part of a merging processes, where one or more submitted changes (e.g., branches) are merged with source code.

At step 304, a compliance analysis of the source code repository is performed. Additionally, or alternatively, a compliance analysis is performed for the SCM system that manages the source code repository in which the code change is detected; however, for the sake of simplicity, only the compliance check of the source code repository is described herein. It should therefore be appreciated that process 300 may be equally applicable to verifying the compliance of an SCM system. As described above, system 200 performs a compliance analysis by first identifying or retrieving a set of compliance rules associated with the source code repository. In some implementations, the set of compliance rules is defined by a user or a third-party specifically for the subject source code repository. In other implementations, a non-repository specific (e.g., general) set of compliance rules is obtained.

Subsequently, or concurrently, system 200 may obtain parameters (e.g., settings) of the source code repository that align with the rules in the set of compliance rules to be evaluated. For example, if the rule requires that “a number of approvals must be set to 1 or more,” then system 200 may retrieve or determine an “approvals” parameter for the source code repository. Each parameter is then compared to an associated compliance rule, and each compliance rule is determined to be “passed” or “failed.” A “pass” indicates that the parameter of the source code repository meets or exceeds the corresponding compliance rule, whereas a “fail” indicates that the parameter of the source code repository does not meet or exceed the corresponding compliance rule.

At step 306, a determination is then made as to whether the source code repository is compliant or non-compliant. In some implementations, the source code repository is deemed compliant if all of the compliance rules are “passed.” In other implementations, only a subset of the compliance rules must be “passed” for the source code repository to be compliant. For example, only a certain number of compliance rules may be considered “must pass” for compliance. If the source code repository and/or associated SCM system is deemed compliant then, at step 308, the code change to the source code is automatically approved for merging with the source code. In other words, the branch created by the user's code change is allowed to merge with the trunk. In some implementations, system 200 may mark, tag, or otherwise indicate the approval. For example, system 200 may change a setting of the source code repository to allow the code change to merge. In some implementations, system 200 sends a command, prompt, or other data to the SCM system and/or repository to indicate approval.

However, if the source code repository and/or associated SCM system is deemed non-compliant then, at step 310, the code change is blocked from merging and/or the code is prevented from being released. For example, system 200 may change a setting of the source code repository to block the code change from being merged and/or may halt a merge process. In some implementations, system 200 sends a command, prompt, or other data to the SCM system and/or repository to cause the SCM system or repository to block the change from being merged. In some embodiments, system 200 intercepts the code change and/or modified source code (e.g., which includes the change) before it is released.

Further, at step 312, a notification may be presented to a user indicating that the source code repository was non-compliant. The notification may be transmitted to a user device (e.g., client device 102), for example, as a text message, email, push notification, etc. In some implementations, the notification provides the user with prompts to take various actions. For example, the notification may prompt the user to view reasons for non-compliance, to schedule a meeting with a development team, to quarantine the non-compliant repository, etc. In some implementations, the notification may allow the user to override the block and thereby allow the change to be merged with the source code even if the associated source code repository is non-compliant. In some implementations, a notification is presented as a message or post in a collaborative communications platform. In this way, multiple users (e.g., of a development team) may be informed of non-compliance at the same time. Additionally, the users may be able to collaborate directly within the collaborative communications platform about the non-compliance issue. An example collaborative communications platform notification is shown in FIG. 11, described below.

Whether or not the source code repository was determined to be compliant or non-compliant, at step 314, a record of the compliance analysis is generated. The record may indicate whether the source code repository was determined to be compliant or non-compliant and may further indicate whether each compliance rule of the compliance analysis was passed or failed. The report may also indicate information such as the time of the compliance check, what prompted the compliance check, etc. In some implementations, the record is then stored in a compliance log for future auditing. In some implementations, the record is presented to a user and/or used to generate a GUI for the compliance analysis. Example records are shown in FIGS. 6 and 7, below. As described above, the report may be presented as a color-coded or non-color-coded console output, or in any suitable format (e.g., Junit, HTML, delimited file, text-based, etc.).

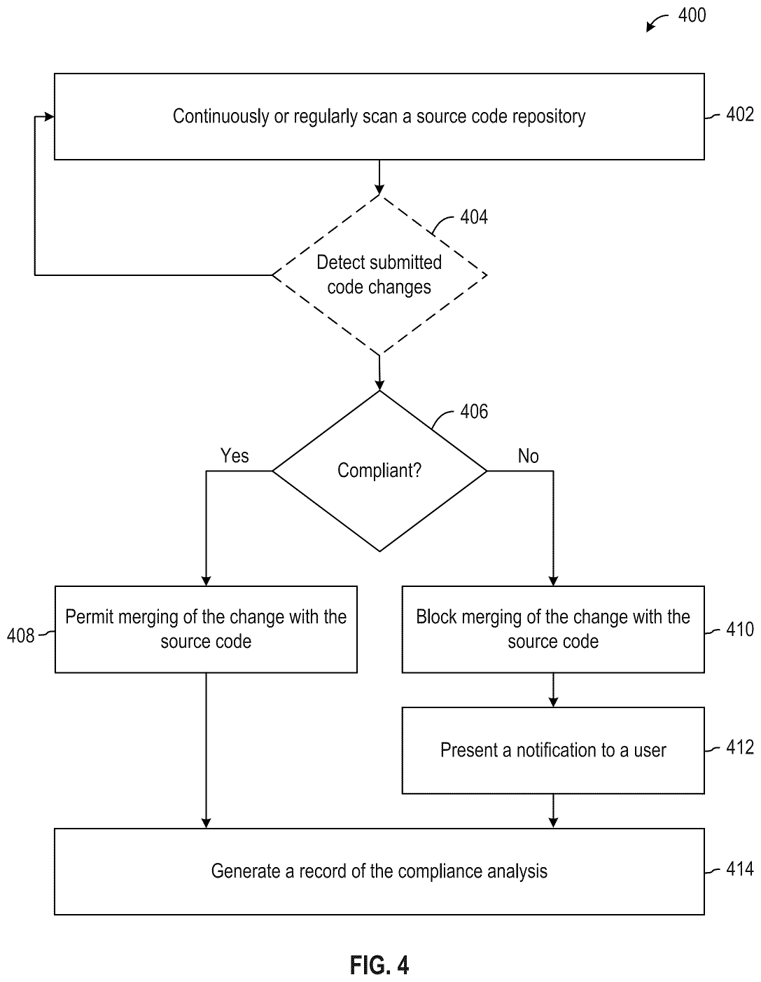

Referring now to FIG. 4, a flow chart of an alternative process 400 for verifying software development compliance is shown, according to some implementations. Specifically, process 400 can be implemented to regularly or continuously scan one or more source code management systems and/or source code repositories for compliance. In some implementations, process 400 is implemented by system 200, as described above. It will be appreciated that certain steps of process 400 may be optional and, in some implementations, process 400 may be implemented using less than all of the steps. It will also be appreciated that the order in which the steps of process 400 are shown is not intended to be limiting.

At step 402, a source code repository or group of source code repositories (and/or their corresponding SCM systems) are continuously or regularly scanned for compliance. Specifically, system 200 may continuously perform compliance analyses on any number of source code repositories (e.g., one at a time) or may be scheduled to perform compliance checks at regular intervals. As described above, system 200 performs a compliance analysis by first identifying or retrieving a set of compliance rules associated with the source code repository. In some implementations, the set of compliance rules is defined by a user or a third-party specifically for the subject source code repository. In other implementations, a non-repository specific (e.g., general) set of compliance rules is obtained.

Subsequently, or concurrently, system 200 may obtain parameters (e.g., settings) of the source code repository that align with the rules in the set of compliance rules to be evaluated. For example, if the rule requires that “a number of approvals must be set to 1 or more,” then system 200 may retrieve or determine an “approvals” parameter for the source code repository. Each parameter is then compared to an associated compliance rule, and each compliance rule is determined to be “passed” or “failed.” A “pass” indicates that the parameter of the source code repository meets or exceeds the corresponding compliance rule, whereas a “fail” indicates that the parameter of the source code repository does not meet or exceed the corresponding compliance rule.

Optionally, at step 404, a system 200 may detect that a change (e.g., modification) to source code in at least one repository has been submitted before a compliance analysis is performed. In some such implementations, step 402 may include scanning one or more source code repositories to detect code changes, rather than continuously/regularly performing compliance checks. In such implementations, if a code change is detected, then a compliance analysis may be triggered.

At step 406, a determination is then made as to whether the source code repository is compliant or non-compliant. In some implementations, the source code repository is deemed compliant if all of the compliance rules are “passed.” In other implementations, only a subset of the compliance rules must be “passed” for the source code repository to be compliant. For example, only a certain number of compliance rules may be considered “must pass” for compliance. If the source code repository and/or associated SCM system is deemed compliant then, at step 408, any code changes are automatically approved for merging with the source code. In some implementations, system 200 may mark, tag, or otherwise indicate the approval. For example, system 200 may change a setting of the source code repository to allow the code change to merge with the source code. In some implementations, system 200 sends a command, prompt, or other data to the SCM system and/or repository to indicate approval.

However, if the source code repository and/or associated SCM system is deemed non-compliant then, at step 410, submitted code changes are blocked from merging or being released. For example, system 200 may change a setting of the source code repository to block the change from be merged with the corresponding source code. In some implementations, system 200 sends a command, prompt, or other data to the SCM system and/or repository to cause the SCM system or repository to block the change from being merged. In some embodiments, system 200 intercepts the code change and/or modified source code (e.g., which includes the change) before it is released.

At step 412, a notification may be presented to a user indicating that the source code repository was non-compliant. The notification may be transmitted to a user device (e.g., client device 102), for example, as a text message, email, push notification, etc. In some implementations, the notification provides the user with prompts to take various actions. For example, the notification may prompt the user to view reasons for non-compliance, to schedule a meeting with a development team, to quarantine the non-compliant repository, etc. In some implementations, the notification may allow the user to override the block and thereby allow the change to be merged with the source code even if the associated source code repository is non-compliant. In some implementations, a notification is presented as a message or post in a collaborative communications platform. In this way, multiple users (e.g., of a development team) may be informed of non-compliance at the same time. Additionally, the users may be able to collaborate directly within the collaborative communications platform about the non-compliance issue. An example collaborative communications platform notification is shown in FIG. 11, described below.

Whether or not the source code repository was determined to be compliant or non-compliant, at step 414, a record of the compliance analysis is generated. The record may indicate whether the source code repository was determined to be compliant or non-compliant and may further indicate whether each compliance rule of the compliance analysis was passed or failed. The report may also indicate information such as the time of the compliance check, what prompted the compliance check, etc. In some implementations, the record is then stored in a compliance log for future auditing. In some implementations, the record is presented to a user and/or used to generate a GUI for the compliance analysis. Example records are shown in FIGS. 6 and 7, below. As described above, the report may be presented as a color-coded or non-color-coded console output, or in any suitable format (e.g., Junit, HTML, delimited file, text-based, etc.).

### Example User Interfaces

Referring now to FIG. 5, an example user interface 500 for establishing or modifying report schedules is shown, according to some implementations. In some implementations, user interface 500 is an example of a GUI generated by notification/UI generator 216. In some implementations, user interface 500 can be presented to a user of client device 102 to allow for configuration of compliance analyses. For example, user interface 500 may allow a user to set or change various settings via configuration tool 214, as described above. As shown, user interface 500 may display a list of scheduled compliance checks and may provide means for a user to add, modify, or delete a scheduled compliance check. In this example, a “run compliance pipeline” activity is scheduled which, when active, causes compliance engine 212 to perform compliance checks of one or more SCM systems or repositories. User interface 500 may also indicate, for each scheduled activity, a target (e.g., a target repository), an identifier for a last compliance check, a date and time of the scheduled compliance check, and an indication of the user that established the scheduled check.

Referring now to FIG. 6, an example user interface 600 of a color-coded console output is shown, according to some implementations. In some implementations, user interface 600 is an example of a GUI generated by notification/UI generator 216 based on a compliance analysis report generated by compliance engine 212. In some implementations, user interface 600 can be presented to a user of client device 102 to present the user with a detailed report of whether a given SCM system or repository passed/failed each predefined compliance rule. In other words, user interface 600 may be an example report generated by system 200. In this example, two compliance rules were evaluated against multiple different repositories. In some implementations, user interface 600 is color coded to delineate passed rules versus failed rules. For example, a rule that was passed may be green while a rule that is failed may be red.

Referring now to FIG. 7, an example user interface 700 of a summary report generated by system 200 is shown, according to some implementations. In some implementations, user interface 700 is an example of a GUI generated by notification/UI generator 216 based on a compliance analysis report generated by compliance engine 212. Specifically, user interface 700 provides a summary of the compliance rule pass/fail rate for a plurality of SCM systems/repositories evaluated by system 200. For example, seven compliance rules are summarized in user interface 700, along with an indication of the number of SCM systems/repositories that passed/failed each rule. Taking the “COMPLIANCE-02” rule, for example, it can be seen that 40 SCM systems/repositories passed the rule while 12 SCM systems/repositories failed.

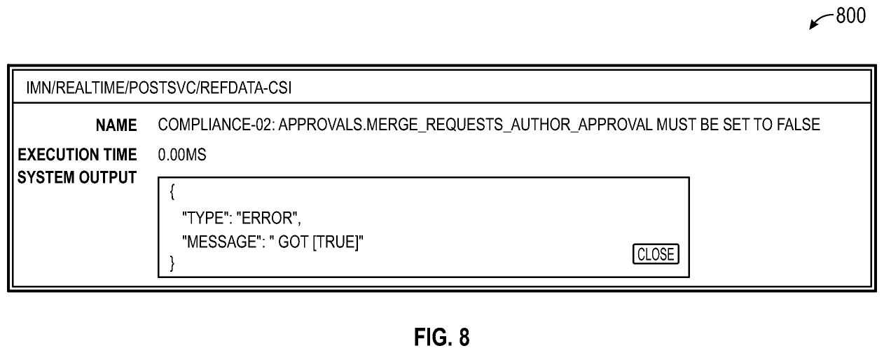

Referring now to FIG. 8, an example user interface 800 for viewing details of various compliance rules, according to some implementations. In some implementations, user interface 800 is an example of a GUI generated by notification/UI generator 216. For example, user interface 800 may be presented to a user as they view or configure compliance rules via configuration tool 214. In this example, a “COMPLIANCE-02” rule is shown, which requires that an “author approval” setting for merging code modifications with source code is set to “False.” In other words, this rule is intended to prevent the authors of code from publishing the code themselves (e.g., without oversight).

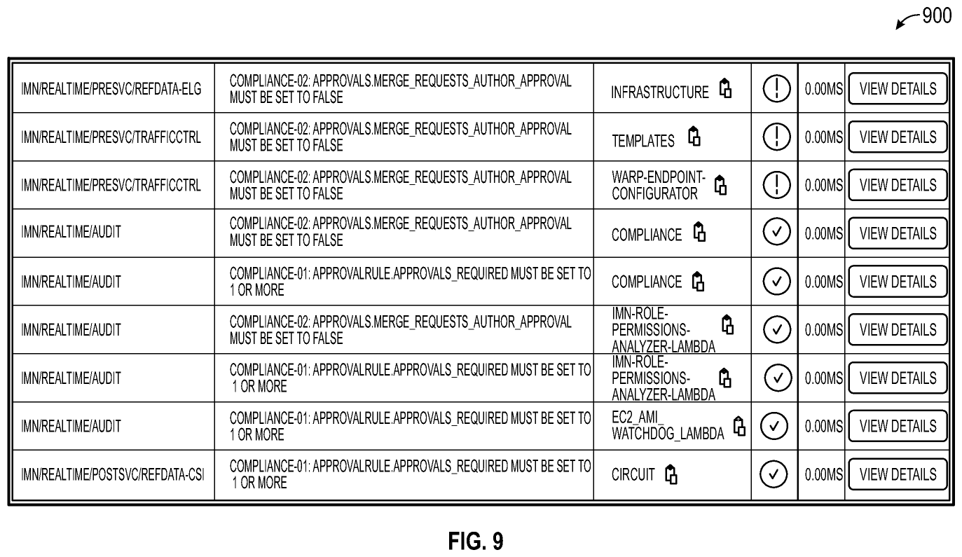

Referring now to FIG. 9, an example user interface 900 for detailed reporting of the results of a compliance analysis is shown, according to some implementations. In some implementations, user interface 900 is an example of a GUI generated by notification/UI generator 216. In particular, user interface 900 displays a list of compliance rules and whether the rules were passed/failed by the corresponding SCM system or repository. User interface 900 also provides additional details relating to each rule, such as the time it took to evaluate the rule. In some implementations, a user can select a “view details” icon to view additional details about each rule (e.g., as shown in FIG. 8, in some cases).

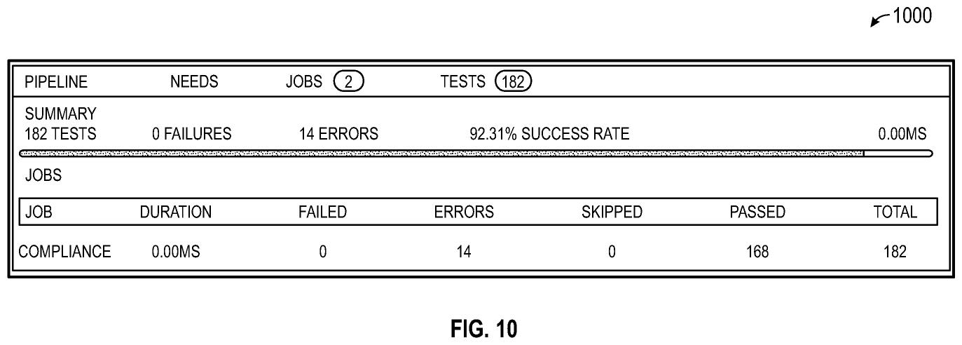

Referring now to FIG. 10, an example user interface 1000 of a summary view completed compliance checks is shown, according to some implementations. In some implementations, user interface 1000 is an example of a GUI generated by notification/UI generator 216. As shown, user interface 1000 displays a summary of all the compliance checks performed by system 200, which may be sorted according to the corresponding SCM system/repository, and indicates the number of rules that are failed, skipped, passed, etc. User interface 1000 may also indicate a total pass/success rate for the completed compliance checks.

Referring now to FIG. 11, an example user interface 1100 of a notification of non-compliance presented via a collaborative communication platform is shown, according to some implementations. In some implementations, user interface 1100 is an example of a GUI generated by notification/UI generator 216. As shown, user interface 1100 is a chat window within a collaborative communication platform in which users can make posts or start chats, to which other users can reply. In this example, a notification of non-compliance was automatically posted (e.g., by system 200) which indicates that there is a compliance issue with an “Advanced RT directory.” As shown, users can reply to the notification, such as to coordinate an effort to address the compliance issue. In some implementations, the notification includes a link or other icon that can be selected by a user to view additional information about the compliance scan. In this example, the user can click on a selectable link to be navigated to a web page for viewing results of a compliance scan.

### Configuration of Certain Implementations

The construction and arrangement of the systems and methods as shown in the various exemplary implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the exemplary implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

What is claimed is:

1. A system for verifying software development compliance, the system comprising:
a processor; and
memory having instructions stored thereon that, when executed by the processor, cause the system to:
determine that a user has submitted a change to source code stored in a source code repository;
before merging the change with the source code:
perform a compliance analysis of the source code repository by comparing parameters of the source code repository against a set of compliance rules; and
block the change from being merged with the source code if it is determined that the source code repository is non-compliant; and
generate a report that includes details of the compliance analysis, wherein the report indicates at least whether the source code repository passed or failed for each rule of the set of compliance rules.

2. The system of claim 1, wherein the instructions further cause the system to automatically approve merging of the change with the source code if it is determined that the source code repository is compliant.

3. The system of claim 1, wherein the instructions further cause the system to present, to a user of a user device, a graphical user interface (GUI) that includes the report.

4. The system of claim 1, wherein the instructions further cause the system to:
generate an alert responsive to determining that the source code repository is non-compliant; and
transmit the alert to a remote user device.

5. The system of claim 1, wherein the system is communicably coupled to the source code repository by an application programming interface (API), and wherein the parameters of the source code repository are retrieved via an API call to the source code repository.

6. The system of claim 1, wherein the system wrapped around an application programming interface (API) for a source code management system that includes the source code repository.

7. The system of claim 1, wherein the report is displayed to a user of the system via a console output and/or is transmitted to a remote device in one or more of a Junit, HyperText Markup Language (HTML), delimited file, or text-based format.

8. The system of claim 1, wherein the instructions further cause the system to receive the set of compliance rules via a user input.

9. The system of claim 1, wherein the set of compliance rules comprise at least one rule where:
a number of approvals for merging the modification with the source code must be greater than one;
an author of the modification to the source code cannot approve merging of the modification with the source code;
the modification to the source code can only be merged with the source code if each step of a software development pipeline is passed;
all discussions relating to the source code repository are completed or closed; or
a visibility of the source code repository is set to private or internal.

10. A method for verifying software development compliance, the method comprising:
determining that a user has submitted a change to source code stored in a source code repository;
before merging the change with the source code:
performing a compliance analysis of the source code repository by comparing parameters of the source code repository against a set of compliance rules; and
blocking the change from being merged with the source code if it is determined that the source code repository is non-compliant; and
generating a report that includes details of the compliance analysis, wherein the report indicates at least whether the source code repository passed or failed for each rule of the set of compliance rules.

11. The method of claim 10, further comprising automatically approving merging of the change with the source code if it is determined that the source code repository is compliant.

12. The method of claim 10, further comprising presenting, to a user of a user device, a graphical user interface (GUI) that includes the report.

13. The method of claim 10, further comprising:
generating an alert responsive to determining that the source code repository is non-compliant; and
transmitting the alert to a remote user device.

14. The method of claim 10, wherein the parameters of the source code repository are retrieved via an application programming interface (API) call to the source code repository.

15. The method of claim 10, wherein the report is displayed to a user of the system via a console output and/or is transmitted to a remote device in one or more of a Junit, HyperText Markup Language (HTML), delimited file, or text-based format.

16. The method of claim 10, further comprising receiving the set of compliance rules via a user input.

17. The method of claim 10, wherein the set of compliance rules comprise at least one rule where:
a number of approvals for merging the modification with the source code must be greater than one;
an author of the modification to the source code cannot approve merging of the modification with the source code;
the modification to the source code can only be merged with the source code if each step of a software development pipeline is passed;
all discussions relating to the source code repository are completed or closed; or
a visibility of the source code repository is set to private or internal.

18. A method for verifying software development compliance, the method comprising:
scanning a source code repository at a regular interval to determine a most recent set of parameters for the source code repository;
performing a compliance analysis of the source code repository by comparing the most recent set of parameters for the source code repository against a set of compliance rules;
blocking any submitted code changes within the source code repository from being merged with corresponding source code if it is determined that the source code repository is non-compliant; and
generating a report that includes details of the compliance analysis, wherein the report indicates at least whether the source code repository passed or failed for each rule of the set of compliance rules.

19. The method of claim 18, further comprising detecting whether a change to code stored in the source code repository has been submitted since a previous scan, wherein the compliance analysis of the source code repository is performed only if a change is detected.

20. The method of claim 18, further comprising automatically approving the merging of any changes with the corresponding source code if it is determined that the source code repository is compliant.
